(19) United States
(12) Patent Application Publication
(10) Pub. No.: US 2018/0130259 A1
(43) Pub. Date: May 10, 2018

(54) System, Device or Method for Collaborative Augmented Reality

(71) Applicant: DOTTY DIGITAL PTY LTD, Wollongong (AU)

(72) Inventors: Philippe Jacques LEEFSMA, Neuchatel (CH); Constantin Victorovich FEDOROV, Malie Vyazemy (RU); Wesley Allister MCCOMBE, Manila (PH); Russell Joseph CONSIDINE, Bella Vista NSW (AU)

(21) Appl. No.: 15/618,449

(22) Filed: Jun. 9, 2017

Related U.S. Application Data
(60) Provisional application No. 62/350,304, filed on Jun. 15, 2016.

(51) Int. Cl. G06T 19/00; G06Q 10/10; G06T 19/20; G06F 3/0481; H04L 29/06

(52) U.S. Cl. CPC G06T 19/006; G06Q 10/101; H04L 29/06034; G06F 3/04815; G06T 19/20

(57) ABSTRACT

A system, device, or method for enabling collaboration with a team of people in an Augmented Reality (AR) environment or Collaborative Augmented Reality (CAR).

Provisional Application No. 62/350,304, filed on Jun. 15, 2016, is incorporated herein by reference in its entirety.

### TECHNICAL FIELD

The invention relates to a collaborative environment, and in particular, the present invention relates to a system, device, or method for enabling collaboration with a team of people in an Augmented Reality (AR) environment or Collaborative Augmented Reality (CAR).

### BACKGROUND

Virtual reality collaboration was a concept conceived long before the existence of the term Augmented Reality. As early as the 1970s, in George Lucas's original Star Wars, remote collaboration was accomplished using life-size virtual images superimposed on the real world. However, not until the 1990s, there was an area of study in mixed reality. It was proposed that virtual environments (or virtual reality) and augmented virtuality referred to the technology of real objects adding to virtual ones, or replacing the surrounding environment by a virtual one. The difference between VR and AR was that AR took place in the real world. Around that time, AR system was defined to: (a) combine real and virtual objects in a real environment; (b) combine real and virtual objects in a real environment; register (aligns) real and virtual objects with each other; and (c) run interactively, in three dimensions, and in real time.

Complex problem solving usually required a team of experts to physically meet and interact with each other. In some areas, the number of available experts were scarce and it was inefficient for them to move around for meetings. If an expert was transported to one location, he/she would be deprived from attend a meeting in person at another remote location. Due to experts' availability, critical timing issues or accessibility of a location, it was not always possible to bring a team together to handle a complex situation. It would be advantageous to have the expert located in a single location while attending problem in remote location under an AR environment.

Since then, there were many attempts to create a collaborative environment with virtual reality or augmented reality.

For example, prior art document U.S. Pat. No. 7,119,829 disclosed a video conference system. The environment of this system included a local conference room and a remote conference room. These conference rooms were electronically coupled together to permit transmission of images from each room to the other room for viewing. Each conference room had a large format display system for projecting images; and a camera positioned with respect to the large format display system. The camera could capture an image of the conference room and a participant in the room, without substantially obscuring the participant's view of the large format display system. This would provide the perception that the participant in the room was looking directly at a participant in the other conference room. The large format display system included an aperture behind which the camera was located. The aperture was deliberately installed so as to coincide with a visually insignificant area of the image of the other conference room as displayed on the large format display system. Thereby, the visually insignificant area would correspond to an image of an unobtrusive physical object located in the other conference room. However, this system merely facilitated the meeting of various team members in two different places or locations, it did not facilitate an augmented reality environment for the team member to interact with an virtual object.

In prior art document US Patent Application No. 20140015831, it was disclosed an apparatus for processing manipulation of a three-dimensional (3D) virtual object. The apparatus comprised an image input unit, an environment reconstruction unit, a 3D object modelling unit, a space matching unit, and a manipulation processing unit. The image input unit was configured to receive image information generated by capturing a surrounding environment including a manipulating object using a camera. The environment reconstruction unit was adapted to reconstructing a 3D virtual reality space for the surrounding environment using the image information. The 3D object modelling unit was for modelling 3D virtual object that was manipulated by the manipulating object, and to generate a 3D rendering space including the 3D virtual object. The space matching unit could match the 3D rendering space to the 3D virtual reality space. The manipulation processing unit configured to determine whether the manipulating object was in contact with a surface of the 3D virtual object, to track a path of a contact point between the surface of the 3D virtual object and the manipulating object, and to process a motion of the 3D virtual object. This apparatus provided a system to manipulate 3D objects in an augmented environment, but it did not provide any teaching or direction to work in a CAR environment.

Prior art document U.S. Pat. No. 9,270,943 disclosed an apparatus which had a sensor, a receiver, and a processor for running computer application stored on a computer readable storage medium. The sensor was adapted to capturing a first set of sensor data concerning a local user's physical environment. The receiver was adapted to receiving a second set of sensor data over a communications network concerning a remote user's physical environment a processor. The computer program caused the processor to detect and extract a subset of points associated with an input received from the remote user over the communication network or the local user; to translate a detected configuration of the subset of points into a detected in-air gesture; and to send information about the detected in-air gesture to the processor. The processor was operable to process an in-air gesture to manipulate an object currently rendered on a virtual workspace display which produced a sharing room to the local user and the remote user. To manipulate an object further comprised to furnish the virtualized workspace with virtualized objects. However, this CAR framework depended on do not provide any teaching or direction of sharing the augmented reality between a team of people efficiently without creating delay and disturbance to the current users.

### SUMMARY

### Problems to be Solved

The present invention relates to a system, device, or method for enable coloration with a team of people in an Augmented Reality (AR) environment or a Collaborative Augmented Reality (CAR).

It is, therefore, an object of the present invention to provide a new and novel for a system, device, or method for enable collaboration with a team of people in an Augmented Reality (AR) environment or Collaborative Augmented Reality (CAR) that allow participant to join and leave the CAR without significant disturbance to the current users.

Other objects and advantages will become apparent when taken into consideration with the following specification and drawings.

It is also an object of the present invention to overcome or ameliorate at least one of the disadvantages of the prior art, or to provide a useful alternative.

It is a first aspect of the present invention to provide a method of Augmented Reality collaboration implement on a computer server for sharing 3D object model with a plurality of electronic devices, comprising the steps of: uploading one or more 3D object model file. to the server; publishing a session identifier associated with the universal sharing files; receiving a request containing the session identifier from the plurality of electronic devices, distributing a universal file of the 3D object model to the plurality of electronic devices in real-time synchronously.

Preferably, the method of Augmented Reality collaboration further comprises the steps of converting the 3D object model files into one or more universal files with a predefined file format, wherein the universal files can be displayed on the plurality of electronic devices as stereographic presentation;

Preferably, the steps of converting the 3D object model files, further comprising the step of invoking a remote application programming interface (API) of a remote server over the Internet, wherein the API is adapted to forward the 3D object model file to the remote server, and return the universal file.

Preferably, the 3D object model files is different to the universal file format.

Preferably, a method of Augmented Reality collaboration further comprises the steps of receiving a modification request from one of the plurality of electronic devices, modifying the universal files in according with the modification request, sending one or more modified universal files to others of the plurality of electronic devices in real-time synchronously.

Preferably, the step of modification the universal files further comprising the steps of invoking another remote application programming interface (API) of a remote server over the Internet, wherein the API is adapted to forward the 3D object model file to the remote server, and return the universal file.

Preferably, the modification request comprises one or more manipulation of the 3D object model.

Preferably, the manipulation of the 3D object comprises one or more of rotation, pan, zoom, explode, animate, hide a part, show a part, highlight a part, display part information, present in a perspective views.

Preferably, the modification request comprises one or more manipulation of scene objects.

Preferably, the manipulation of the scene object comprising one or more of modifying viewport, modifying light source, modifying ambient light, modifying camera position, and modifying background.

Preferably, the session identifier comprises a Uniform Resource Locator (URL) bar code and/or two-dimension barcode.

Preferably, the step of distributing a universal file of the 3D object model include distribution of a media steam in real-time along with the universal file of 3D object model.

A method of Augmented Reality collaboration of any one of Claims 1 to 12, wherein the step of uploading one or more 3D object model files to the server comprising the steps of connecting to a physical object through a wireless means, and retrieving the 3D object model file of said physical object from said physical object.

It is a second aspect of the present invention to provide a method of Augmented Reality collaboration implement on a first electronic device for sharing 3D object model with other electronic devices, comprising the steps of: sending a request to a server, receiving a universal file of the 3D object model in real-time synchronously with other electronic devices, wherein the universal file converted from the 3D object model file uploaded to the server; displaying the universal file on the display as a stereographic presentation.

Preferably, a method of Augmented Reality collaboration of Claim 12, further comprising the step of scanning an image, and retrieving a session identifier associated to the image.

Preferably, a method of Augmented Reality collaboration of Claim 13, wherein the image comprises a URL, barcode and/or two-dimension barcode, wherein the electronic device retrieves the session identifier in the image.

Preferably, a method of Augmented Reality collaboration of Claim 13, wherein the image comprises an real-life object, wherein the electronic device is adapted to connecting to the server, and retrieving the session identifier associated with the image.

Preferably, the step of sending the request comprising the steps of: opening a network socket on the server; and forwarding the request to the server through the network socket, wherein the request comprising the session identifier and the host name.

Preferably, the method of Augmented Reality collaboration further comprises the steps of: receiving an input from a user to modify the stereographic presentation, and sending a modification request to the server.

Preferably, the method of Augmented Reality collaboration further comprises the steps of:

receiving one or more universal files from the server; and

displaying the one or more modified universal files in real-time synchronously with one or more electronic devices sharing a same session identifier.

It is another aspect of the present invention to provide an electronic device comprising:

a processor;

a peripherals interface comprising an electronic communication system for communicating with a server or other electronic device via one or more of wired or wireless communication protocol;

a memory interface for storing instructions set to be executed by the processor; and

an input and output (I/O) subsystem comprising a touch-surface controller for receiving inputs and displaying output,

wherein the processor is adapted to execute the instructions set for a method comprising the steps of:

sending a request to the server through the peripherals interface,

receiving a universal file of the 3D object model through the peripherals interface in real-time synchronously with other electronic devices, wherein the universal file is converted from the 3D object model file uploaded to the server;

displaying the universal file on the touch surface as a stereographic presentation.

Preferably, the processor is adapted to execute the instructions set for a method comprising the steps of:

receiving an input from a user on the touch surface to modify the stereographic presentation,

sending a modification request to the server based on the input, wherein the modification request is encoded in a file format different to that of the universal file format;

receiving one or more universal files from the server; and

displaying on the touch screen the one or more modified universal files in real-time synchronously with one or more electronic devices sharing a same session identifier.

Preferably, the input and output (I/O) subsystem comprises a touch-surface controller for controlling a touch surface, or a pointer device controller for controlling a pointer device.

### BRIEF DESCRIPTION OF THE FIGURES

FIG. 1 is a schematic diagram of an augmented reality collaboration service according to a first preferred embodiment of the invention;

FIG. 2 is a schematic diagram of an augmented reality collaboration process of FIG. 1;

FIG. 3 is a screen shot of a User Interface (UI) for signing up an account to use collaboration service of FIG. 1;

FIG. 4 is a screen shot of a UI for uploading AR data (e.g., a 3D model) to the collaboration service of FIG. 1;

FIG. 5 is another screen shot of a UI for uploading a 3D object model to the collaboration service of FIG. 1;

FIG. 6 is a screen shot of a UI for viewing a loaded model of the collaboration service of FIG. 1;

FIG. 7 is a screen shot of a UI allowing users to animate and modify the model (e.g., by exploding the model as shown) of the collaboration service of FIG. 1;

FIG. 8 is a screen shot of a UI for creating a collaboration session using the model of the collaboration service of FIG. 1;

FIG. 9 is a screen shot of a generated and sharable QR code providing a link to the collaboration environment of the collaboration service of FIG. 1;

FIG. 10 is a screen shot of an in-app UI for joining a collaboration session of the collaboration service of FIG. 1;

FIG. 11 is a screen shot of a model being displayed in augmented reality of the collaboration service of FIG. 1 on the screen of a smartphone device;

FIG. 12 is a screen shot showing changes made in real time on the browser or in the app may propagate to all participants of the collaboration service of FIG. 1;

FIG. 13 is a schematic diagram of a client device according to an embodiment of the invention; and

FIG. 14 is a schematic diagram of a server according to an embodiment of the invention.

### DETAILED DESCRIPTION

Systems and methods described herein may provide collaborative augmented reality (AR). For example, a plurality of computing devices may be in communication with one another and/or with one or more remote servers using a network. A computing device may be one of a variety of electronic devices including, but not limited to, laptop computers, desktop computers, computer terminals, television systems, tablet computers, e-book readers, smart phones, watches, and wearable computers. Each device may present the same AR display (e.g., three dimension (3D) model content, including display through wearable AR glasses such as Google Glass™, Epson Moverio™, ODG, and MagicLeap™), and manipulations to the AR content on display made on one device may be shared with other devices.

AR scenes may be manipulated on a device in real time (e.g., rotate, pan, zoom, explode, hide parts, show parts, highlight parts, display part information, animate, etc.) and the viewing state resulting from the manipulations may be shared with other devices over a network.

A variety of AR model formats may be translated to a universal file format (e.g., WebGL) using an external application programming interface (API). The formatted AR model may be shared over the network, for example in a browser environment. Individual devices may decode the formatted AR model data for use with device-specific hardware, software, and/or firmware (e.g., for use with a specific type of AR glasses or other display).

For example, device users may join collaboration sessions using a common meeting URL (Universal Resource Locator) link which may load the same AR model scene on all devices in real-time and simultaneously.

In some embodiments, AR scenes may be presented in a collaborative interactive boardroom. Thereby allowing multiple people to visualise the same 3d model at multiple locations in real-time. Modifications and changes to the 3D model may be replicated and viewed in realtime.

An example user interaction with the AR collaboration system may proceed as follows. A device user may upload a 3D model to a remote server. The user, and other users with other devices, may be able to receive data from the remote server and view the 3D model using a web browser or other program. The user may be able to pre-sequence animations for a presentation of the 3D model.

The user may create a collaboration link (e.g., a URL and/or QR code) that may be sent to collaborators (e.g., using email, Skype, text message, chat platforms, or the like).

Collaborators may join the live collaboration session using the link in a browser or dedicated collaboration app. The user may manipulate the 3D model during the collaboration session, and all participants may see the manipulations to the 3D model using their own devices.

In one embodiment of the present invention, there is provide real-time AR collaboration along with video conferencing. In one embodiment, the display provides two separated sessions—one steaming real-time video conference using WebRTC, and the other provide an 3D model for the participants to manipulate. In another embodiment, the 3D model is overlaid on top the video conferencing steam so that both steams are displayed on the same screen.

The present invention may also provide 3D model exchange (one out, one in) during a collaboration session. In one embodiment, the system is a fully transparent collaboration platform for everything to appear in mixed reality (Augmented) for multiple participants.

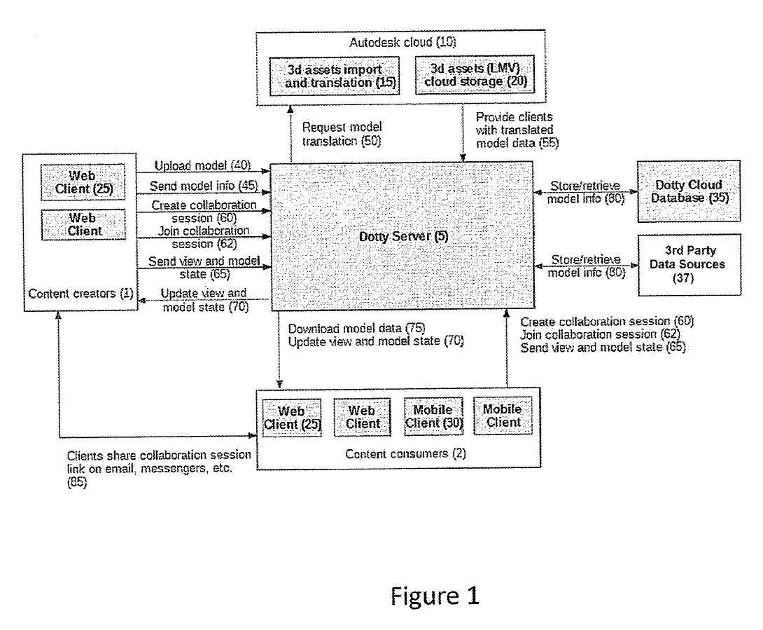

FIG. 1 is an AR collaboration service according to an embodiment of the invention. A plurality of client devices may communicate with one another and/or with one or more servers. For example, a content creator may use a first device 1, and content consumers may use one or more second devices 2. Content creators may be clients that create 3D models or other AR content for use in the AR collaboration service. Content consumers may be clients that can open and view available 3D models, create new collaboration sessions, and/or join existing sessions.

Clients 1 and 2 may connect to a server 5. Server 5 may communicate with translation server 10 (e.g., Autodesk cloud service) to translate models from a large set of supported 3D file formats (more than 70 are supported at the moment) into universal intermediate 3D scene format (view and data format). Translated models may be saved to cloud storage 20 (e.g., Autodesk cloud service) and may be retrieved by server 5 on demand from clients 1 and 2. Additional model properties may be saved to the collaboration service cloud database 35. In some embodiments, data may be distributed differently (e.g., one of the aforementioned databases 20 and 35 may store all data).

In another embodiment, the Server 5 may connect to one or more third party data source 37 to search and retrieve data and/or 3D models. The connectivity of 3rd party data sources provide an enormous library for the system of an embodiment of the present invention. In most situation, the system may recognise the object. The system will then connect to a third-party data source 37 and retrieve

In another embodiment of the present invention, the system allows the collaborative AR for the internet of things. Think of lots of data sources all displayed, searchable and manageable through the 3D layer that users can control collaboratively. The object itself has already the 3D object model stored within. The system of the present invention may connect to the object itself through near field connection, such as Bluetooth, Wi-Fi, etc. In one embodiment, the system scans a marker (bar code or serial number) on the object, the marker provides an address to download the 3D blueprint. In another embodiment, the system may request the 3D blueprint of the object itself and the object will send the 3D blueprint to the system. The object itself may also provide the current object current status along with the 3D blueprint, such that the system of the current invention can display the 3D object along with the real-time status of the object.

Employment of the universal intermediate format may allow for better feature support across clients running on different operating systems, independently from the feature set available in the original model file format. Invariant nature of the underlying data may make it possible to build a collaboration interactions system on top of the underlying data along with a set of basic 3D editing tools. The collaboration infrastructure and environment may use this universal file format.

A collaboration session may be created by any client, given that client has access to the service and selected 3D models. Collaboration server may generate unique session URL and session 2D marker image (e.g., a QR code). These session identifiers may be shared over email, instant messaging applications, or other means of digital communications. Other participants may join session by opening the URL in the web browser, opening it in the mobile app, or scanning 2D collaboration marker in the mobile app, for example. The marker may be scanned from a hard copy or directly from the screen.

During the session, clients may rotate, pan, zoom in or out, hide or show some parts of the model, display part information, play predefined animations to some predefined states of the 3D object, highlight object elements, etc. All changes that one client does may be propagated to all other clients through the connection provided by server 5. This may provide almost real time synchronization of the state between clients (with lag of 0.5-1 second in some embodiments).

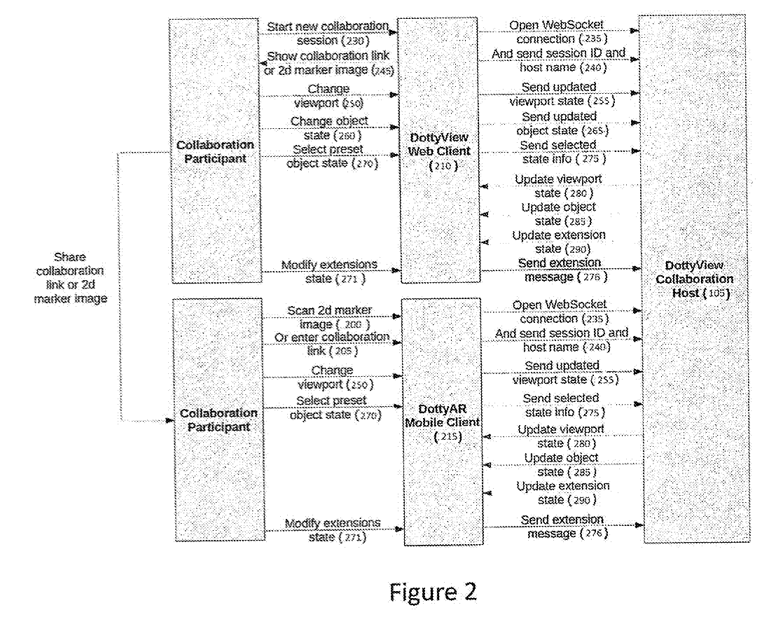

FIG. 2 is an augmented reality collaboration process according to an embodiment of the invention. In this example, a new collaboration session may be initiated by a participant using Web Client (210). Mobile Clients (215) may join existing collaboration sessions in this example.

By request from the participant, Web Client may create a new unique session identifier (ID) and may ask for participant's nickname. Network socket or New Web Socket connection (235) may be established to the Collaboration Host (105). After the connection is established, Web Client may send session ID and nickname to the host.

In some embodiments, a message with the session ID and nickname may have the following format:
Message identifier:“Collaboration.Users”

Payload: {

“meetingid”:¹¹ MEETING_ID”,
“users”:[“Host”]

}, where MEETING_ID is a unique session identifier.

A collaboration session link may be generated along with a 2D marker image identifying that session, and the link and/or image may be presented to the participant in the Web Client UI. In some embodiments, a collaboration link may have the following format:
http://trial.dotdotty.com/collaboration?meetingid=MEETINGID where MEETING ID is a unique session identifier, for example b8ab-a883-2328.

2D marker image may include a superposition of Vuforia frame marker and QR code, containing an encoded collaboration link.

In some embodiments, server may push a notification to client including a link or invitation to join the collaboration (e.g., instead of or in addition to creating a link or 2D image for sharing).

When a collaboration session has been created, participants may join. Participants joining existing collaboration sessions may use the link or may have access to 2D marker image to scan it with the mobile client. Session ID may be extracted from the link or QR code. Client may ask participant's nickname and open Web Socket connection to Collaboration Host. When connection is established, Client may send a message with session ID and nickname to the host. Message format may be as follows in some embodiments:

Message identifier:”Collaboration.JoinMeeting”
Payload: {

“meetingid”:”MEETING_ID”,
″users″:[″Host″]

}, where MEETING_ID is a unique session identifier.

On successful attempt to connect the session, host may send initialization message back to the client, for example according to the following format in some embodiments:

Message identifier: ″Collaboration.Stateinit″
Payload: {

″viewportState″:“{

“guid”: ”Bba 36cd01554f92744f”,
“seed URN”:

“dXJuOmFkc2sub2JqZWN0czpvcy5vYmplY3Q
6ZG90dHktZ2FsbGVyeS10cmFuc2llbnQtYnVja
2V0LzBlOGitNDljYiliZTI3LWI
zNGEtYjlhMS5pZmM= “,

”objectSet”: [{

“id”:[ ],
“isolated”: [ ],
“hidden”: [ ],
″explodeScale”:0,
“idType”:”lmv”

}],
”viewport”: {

“name”:””,
”eye”: [0,0,1763.3125],
”target”: [0,0,O],
”up”:[0,0,1],
”worldUpVector”:[0,0,1],
”pivotPoint”: [0,0,0],
”distanceToOrbit”:1763.3125,
”aspectRatio”:1.940990516 3329821 ,
”projection”: “perspective”,
“isOrthographic”: false,
”fieldOfView“:44.99999100695533

},
”renderOptions”:{

“environment”:”SimpleGrey”,
“ambientOcclusion”:{

“enabled” :false,
”radius” :l0,
”intensity” :0.5

},
”toneMap”: {

“method” :0,
“exposure“ :0,
“light Multiplier”: 0

},
”appearance”: {

“ghostHidden” :true,
“ambientShadow”: false,
“antiAliasing” :true ,
”progressiveDisplay”: false,”
displayLines“:true

}

}

}“ ,
″objectState″:“{

“ guid″:”8ba36cd01554f92744f”,
“seed URN”:

“dXJuOmFkc2sub2JqZWN0czpvcy5vYmplY3Q6ZG90d
HktZ2FsbGVyeS10cmFuc2llbnQtYnVja2V0LzBlOGitN
DljYiliZTI3LWizNGEtY jlhMS5pZmM=“,

“objectSet”:[{

“id”:[ ],
“isolated”:[ ],
”hidden”:[ ],
”explodeScale”:0,
”idType”:”lmv”

}],
”viewport”:{

“name”:”“,
”eye”:[0,0,1763.3125],
”target”: [0,0,O],
”up”:[0,0,1],
”worldUpVector”:[0,0,1],
”pivotPoint”:[0,0,0],
”distanceToOrbit”:1763;3125,
”aspectRatio”:l.9409905163329821,
” projection”:”perspective”,
“isOrthographic”: false,
”fieldOfView” :44.99999100695533

},
”renderOptions”:{

“environment”:“SimpleGrey”,
“ambientOcclusion”: {

“enabled“: false,
”radius” :l0,
”intensity” 0.5

},
”toneMap”:{

“method”:0,
”exposure“:0,
”light Multiplier”: 0

},
”appearance”: {

“ghostHidden”: true,
”ambientShadow”: false,
”antiAliasing”: true,
” progressiveDisplay“: false,
” displayLines”:true

}

}

}“,
″renderState″:“{

“guid”:“8ba36cd01554f92744f”,
“seedURN”:

“dXJuOmFkc2sub2JqZWN0czpvcy5vYmplY3Q6ZG9
0dHktZ2FsbGVyeS10cmFuc2llbnQtYnVja2V0LzBlO
GitNDljYiliZTI3LWizNGEtY jlhMSSpZmM=“,

“objectSet”:[{

“id”: [ ],
”isolated”:[ ],
”hidden”: [ ],
“explodeScale”: 0,
”idType”:”lmv”

}],
”viewport”:{

“name”:““,
“eye”:[0,0,176 3.3125],
”target”: [0,0,0],
”up”:[0,0,1],
”worldUpVector”:[0,0,1],
”pivotPoint”:[0,0,0],
”distanceToOrbit” :176 3.3125,
”aspectRatio” :l.9409905163329821,
”projection”: ”perspective”,
”isOrthographic”: false,
”fieldOfView”:44.99999100695533

},
”renderOptions”:{

“environment”:”SimpleGrey”,
“ambientOcclusion”:{

“enabled”: false,
”radius”:l0 ,
”intensity” :0.5

},
”toneMap”:{

“ method”:0,
”exposure“: 0,
”light Multiplier”:0

},
”appearance”:{

“ghostHidden”: true,
”ambientShadow”: false,
”antiAliasing”: true,
”progressiveDisplay”: false,
”displayLines” :true

}

}

}″,
″viewablePath″:

“https://developer.api.autodesk.com/viewingservice/vl/it
ems/urn:adsk.viewing:fs.file:dXJuOmFkc2sub2JqZWN0
czpvcy5vYmplY3Q6ZG90dHktZ2FsbGVyeS10cmFuc2l
lbnQtY
nVja2V0LzBlOGitNDljYiliZTI3LWizNGEtYjlhMS5pZ
mM=/output/0/0.svf“,

“meetingid″: “0bal-df3d-ae60“,
″modelId″: ″574650e96336ab5b3d694763″,
″extensionids″:•[

″Dotty.Viewing.Extension.AnimationManager″,
″Dotty.Viewing.Extension.MetadataManager″

]
“chatHistory”: [ ],
″urn″:

“dXJuOmFkc2sub2JqZWN0czpvcy5vYmplY3Q6ZG90dHktZ2Fsb
GVyeS10cmFuc2llbnQtYnVja2V0LzBlOGitNDljYiliZTI3LWizN
GEtYjlhMSSpZmM=″,

″modelLink”: “http://trial.dotdotty.com/share?shareid=7f1-acaaf-8 349-
4ccd-d225″

}

Initialization message may contain all data to setup the viewer and synchronize its state across all participants. In case of error, host may return an error message which may have the following format in some embodiments:

Message identifier:″Collaboration.Error″
Payload: {

″meetingid″:″MEETING_ID″,
″username″: ″User″,
″error″:{

“code”: “Errorcode″,
″description″: ″Errordescription″

When a client has joined a collaboration session and synchronized state with other participants, it may send messages about any state modifications done by the user to the host. Host may propagate these messages to clients sharing the same collaboration session. Clients may remain connected to the collaboration session until explicitly disconnected or disconnected due to network error. The following are example state messages that may be implemented in some embodiments:

Viewport state (255): a message reflecting changes in current camera position and zoom level.

Message identifier:“ Collaboration.StateChanged”Payload:. {

“meetingid”:″0bal-df3d-ae60″,
“ state″:″ {

″viewport”:{

“name”:”“,
”eye”:[−640.922308991264, 2062.4056017780063,

1266.4557774344307],

”target”:[0,0,0],
”up”:[0.15072304470146,0.4830579504785857,

0.8626238076950729],

”worldUpVector”:[0,0,1],
”pivotPoint”:[0,0,0],
”distanceToOrbit”:2503.6390531794,
”aspectRatio”:l.9210 526315789473,
”projection”:“ perspective”,
“isOrthographic”:false,
” fieldOfView”:44.99999100695533

},
“ stateType“:″viewport″,
“filter″:{

″guid″:false,
″seedURN″:false,
″objectSet″:false,
″viewpoint″:true,
″renderOptions″: false

}

}

Object state (265): a message reflecting object state changes such as highlight of the selected nodes, visibility of nodes, exploded view scale of the model.

Message identifier: “Collabora tion.StateChanged″
Payload: {

″meetingid″: ″0bal-df3d-ae60″,
″state″:″{
″objectSet″:[{
″ id″:[ ],
″isolated″:[ ],
″ hidden″:[8],
″explodeScale″:0,
″idType″:″lmv″
}]

}″,

″stateType″: ″object″,
″filter″: {

″guid″: false,
″seedURN″: false,
″objectSet″: true,
″viewport″: false,
″renderOptions″: false

}

}

Rendering options: a message sent to update Client 3D rendering options.

Message identifier: ″Collaboration.StateChanged″
Payload: {

″meetingid″: ″0bal-df3d-ae60″,
″state″: ″{

″renderOptions″:{

″environment″:″GreyRoom ″,
″ambientOcclusion″: {

″enabled″: false,
“radius” :l0 ,
″intensity” :0. 5

},
″toneMap″:{

“method″:l,
“exposure”: −l,
″lightMultiplier″:−1

},
“appearance”: {

“ghostHidden”:true,
”ambientShadow”: false,
”antialiasing” :true,
″progressiveDisplay”: false,
″displayLines″:true

}

}

}″,
″stateType″: ″render″, ″filter″: {

″guid″: false,
″seedURN″: false,
″objectSet″: false,
″viewport″: false,
″renderOptions″: true

}

}

UI components state: a message sent to update visibility, position, and state of controls of several viewer UI components. For example, the following is a visibility message for object properties panel:

Message identifier: “Collaboration.UIMessage”
Payload: {

″meetingid″:″0bal-df3d-ae60″,
″uiMsgid″:″PropertyPanel.Visible″,
″args″:{

″show″ :true

}

}

The following is a position and controls state for object properties panel:

Message identifier: ″Collaboration.UIMessage″
Payload: {

“meetingid”: “0bal-df3d-ae60″,
“uiMsgid″:″PropertyPanel.Style”,
″args″:{
″scroll″:0,
″style″ {
″left″:″1525px″,
″top″:″″,
″height″:””,
“Width”: “”
}

}

In addition to state messages, a client may send extension messages. For example, Web Client may include a core viewer and a set of extensions. An extension may include code and/or modules that may be added on to the core viewer (e.g., Javascript) to allow model changes to occur in the web browser environment (e.g., rotate, pan, zoom, explode, hide parts, show parts, highlight parts, display part information, animate, etc.). Extensions may be added (e.g., through user creation and/or installation). To allow extensions to correctly take part in the collaboration session, extension messages may be used.

For example, the following is an animation extension message to perform animated transition to predefined state.

Message identifier: ″Collaboration.ExtensionMessage″
Payload: {

″extension″: {

“id” : ″Dotty.Viewing.Extension.AnimationManager″,
″msgid″: ″Collaboration.AnimationManager.Animate″

},
″period″: 2,
“fragidMap”: {

“10”: true,
″48″: true

},
″state″: {

″guid″: ″a9c70e94154f0f23c19″,
″seedURN″:

“dXJuOmFkc2sub2JqZWN0czpvcy5vYmplY3Q6ZG
90dHktZ2FsbGVyeS10cmFuc2llbnQtYnVja2V0LzBl
OGitNDljYiliZTI3LWizNGEtYjlhMS5pZmM=″,

“overrides”: {

″transformations″: [ ]

},
″objectSet″: [
{

“id″: [ ],
″isolated″: [ ],

″hidden″: [ ],

″explodeScale″: 0,
″idType″: “lmv”

}],
″viewport″: {

″name″: “”,
″eye″: [

−1799.5505545413673,
−1353.6790147233664,
520.157985106389

],
″target″: [

−179.21808001792806,
−760.1698451978307,
−194.23433564700179

],
″up″: [

0.358746401536816,
0.13272702867012515,
0.923950515582293

],
“worldUpVector”: [

0,
0,
1

],
″pivotPoint″: [

0,
−476.75,
−22

],
″distanceToOrbit″: 2047.3136716640322,
″aspectRatio″: 2.1218697829716193,
″projection″: ″perspective″,
″isOrthographic″: false,
″fieldOfView″: 44.99999100695533

},
″renderOptions″: {

″environment″: ″Riverbank″,
″ambientOcclusion″: {

″enabled″: false,
″radius″: 10,
″intensity″: 0.5

},
″toneMap″: {

″method″: 1,
″exposure″: −5.7,
″lightMultiplier″: −le−20

},
“appearance″ : {

″ghostHidden″: false,
″ambientShadow″: false,
″antiAliasing″: true,
″progressiveDisplay″: false,
″displayLines″: false

}

},
″cutplanes″: {
},
″stateFragids″: {

″2”,
“4”
″6″,
″20″,
″22”,
″48″

},
″transformMap″: {

″10″: {

″position″: {

″x″: −405.8929443359375,

″Y″: 0,
“z”; 0

},
″quaternion″: {

“_X”: 0,
″_y″: 0,
″_z″: 0,
“_w″: 1

}

},
″48″: {

″position″: {

″x″: 0,
″y″: 7.309293746948242,
“z” : 0

},
″quaternion″: {

“_x″: 0,
“_y″: 0,
“_z″: 0,
“_w″: 1

}

}

},
″name″: ″Sub assembly in″

}
“meetingid”: ″MEETING ID″

}

The following is an example animation extension message to adjust position and rotation of one of the object nodes.

Message identifier: ″Collaboration.ExtensionMessage″
Payload: {

″extension″: {

″id″: ″Dotty.Viewing.Extension.AnimationManager″,
″msgid″: “Collaboration. AnimationManager.Transform”

},
“transformMap”: {

“0”: {

″position″: {

″x″: 616.7032470703125,
″y″: 1281.7774658203125,
″z″: −10.229703903198242

},
″quaternion″: {

“_X”: 0,
″_y″: 0,
“_Z”: 0,
“_W”: 1

}

}

}
“meetingid”: ″MEETING_ID″

}

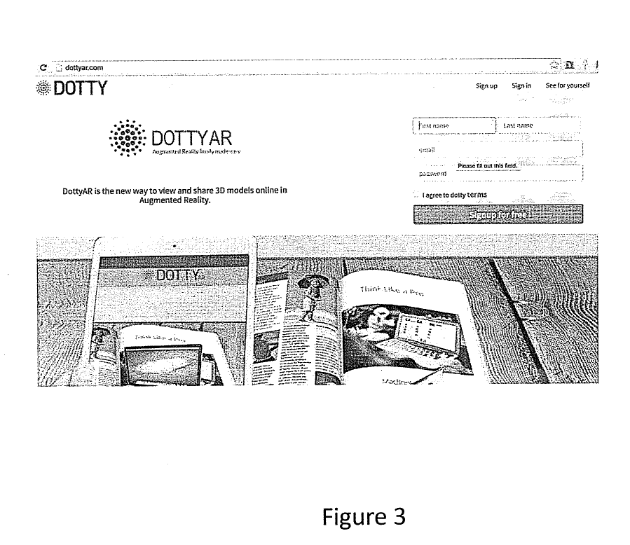

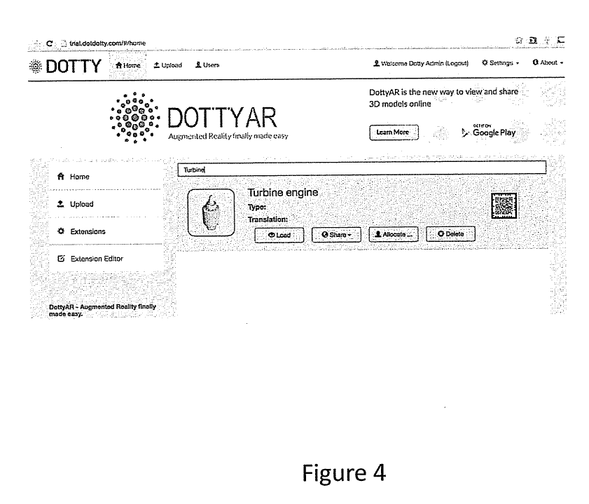

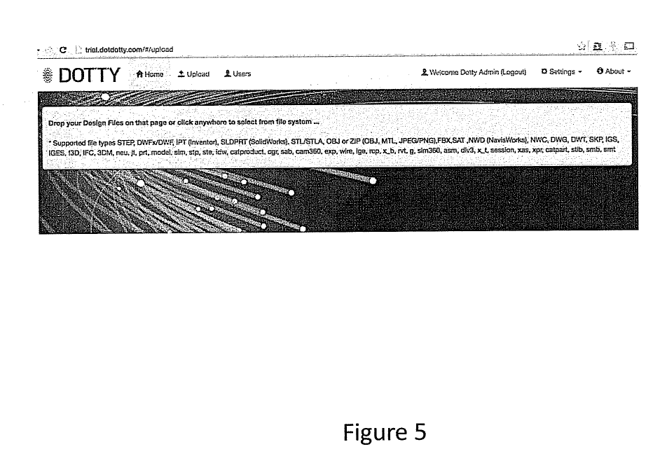

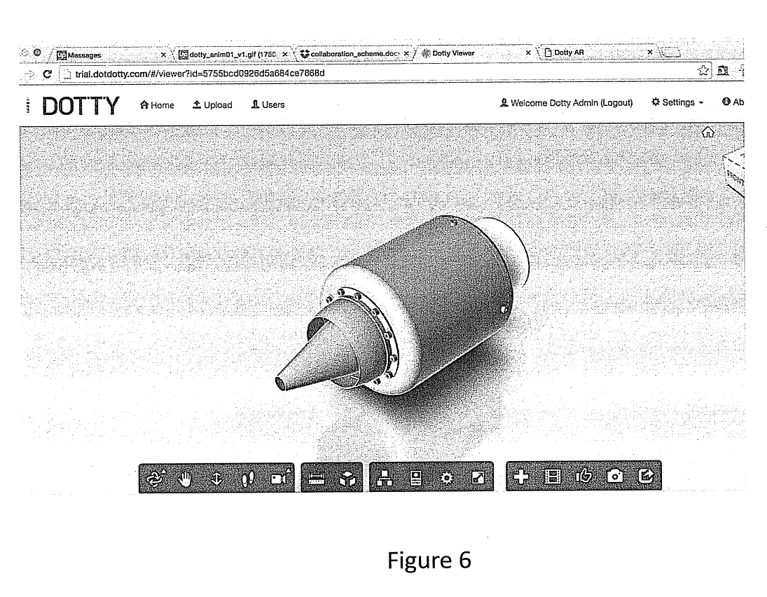

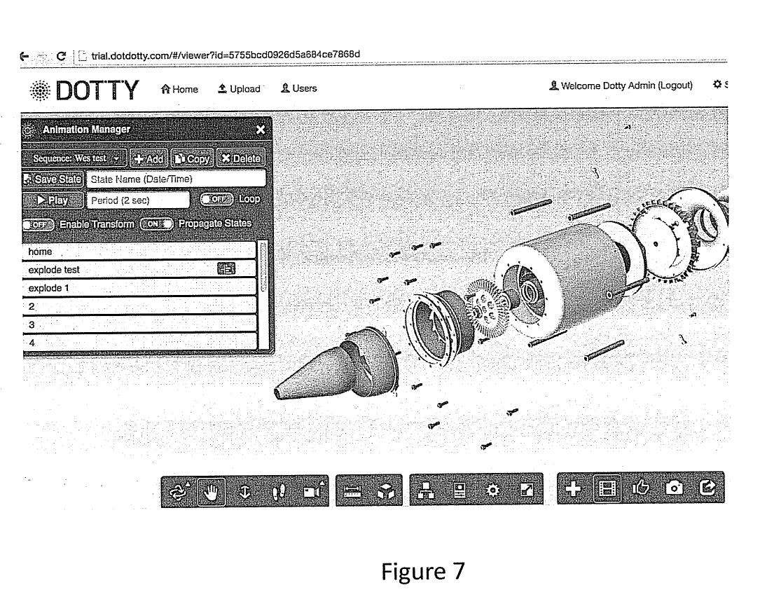

FIGS. 3-12 are screenshots according to an embodiment of the invention. FIG. 3 shows a browser based UI for signing up for an account to use with the collaboration system. Upon registration, a user may be assigned a personal storage area in the server to store translated 3D models for collaboration. FIG. 4 shows a UI for uploading AR data (e.g., a 3D model) to the server. FIG. 5 shows a UI for loading a model. FIG. 6 shows a UI for viewing a loaded model in the browser. As shown in FIG. 7, the UI may allow users to animate and modify the model (e.g., by exploding the model as shown).

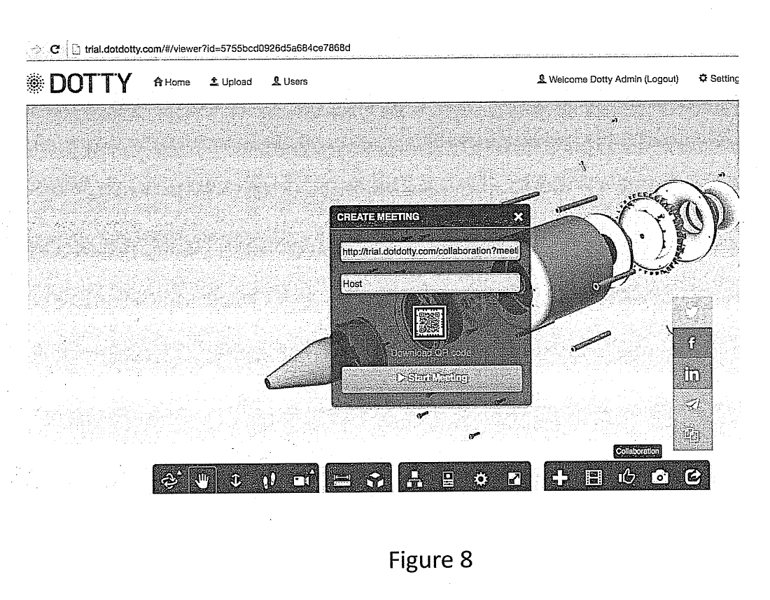

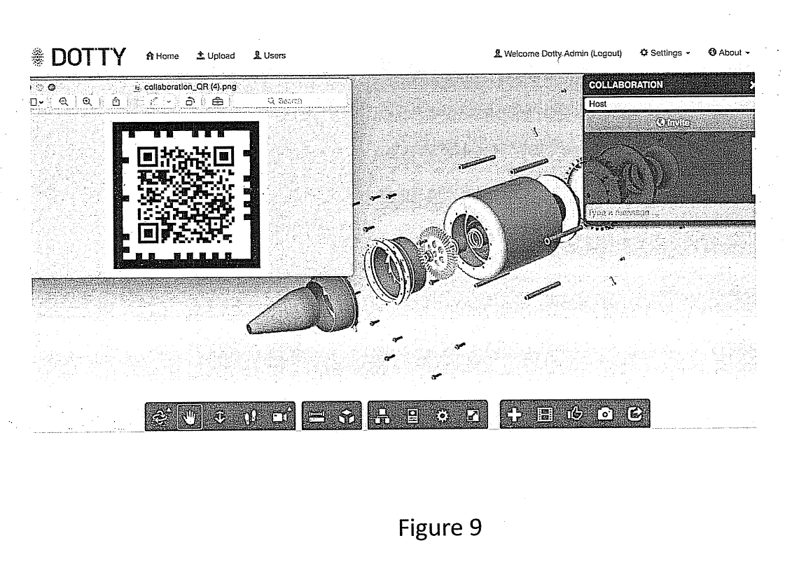

FIG. 8 shows a UI for creating a collaboration session using the model. Users may also be able to create share links and screenshots which can also be shared via the web environment. For example, FIG. 9 shows a generated and sharable QR code providing a link to the collaboration environment. The collaboration session may be unique to a single meeting instance and may be destroyed when the host leaves the meeting or the internet is disconnected.

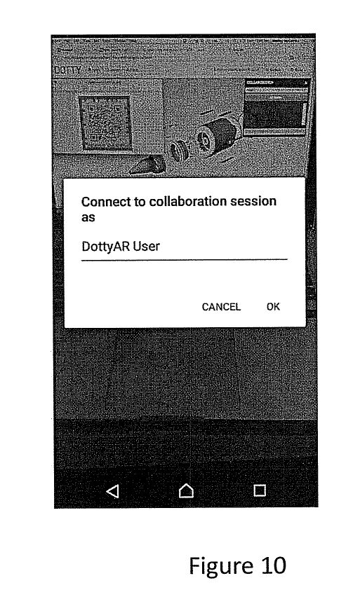

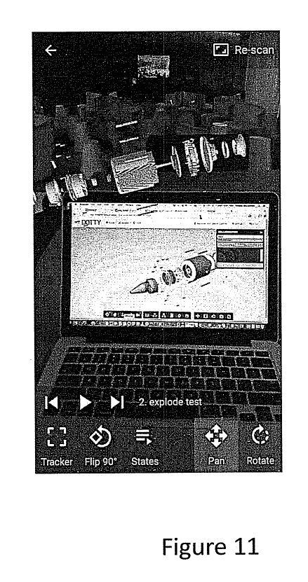

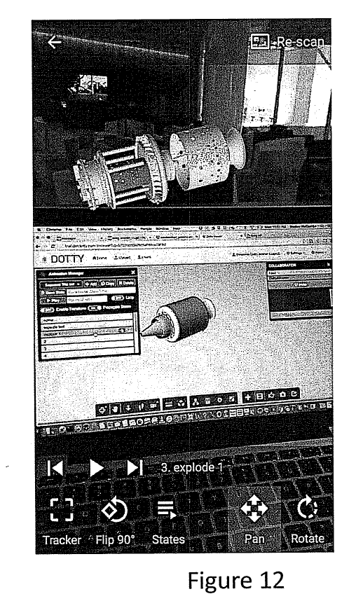

FIG. 10 shows an in-app UI for joining a collaboration session. For example, a user may have scanned the QR code from FIG. 9 using the app and may now be connecting to the associated collaboration session. FIG. 11 shows an example of the model being displayed in augmented reality on the app and the browser simultaneously (e.g., the browser and app devices are collaborating). As shown in FIG. 12, changes made on the browser or in the app may propagate to all participants in real time.

Some embodiments may include one or more of the following features:

(i) Autodesk's intermediate format which only has client libraries for web browsers may be used for AR scenes in some embodiments. However, these embodiments may also include a native library for loading 3D models in View and Data format on Google's Android platform for smart devices and wearable AR devices such as Google Glass. Support for Apple's iOS devices may be provided as well;

(ii) Vuforia Augmented Reality SDK from PTC Inc. may be used to allow the app to augment real world objects (so called trackers) with the loaded model. This may allow for hands-free, live AR interaction environments, such as using a board room table to setup a virtual collaborative work environment;

(iii) Six Degree of Freedom tracking on a VR/AR device such as VR/AR glasses from Osterhout Design Group. Further, it is envisaged that the current invention is adapted to support any other tracking mechanism.

3D object pose may be transformed from 360-degree free rotation on the web to a pose limited in 90 degree rotations aligned to the tracker plane and the free rotation around vertical axis on mobile clients to create an augmented viewing experience best suited to each display type.

For connection to the collaboration session, unique session ID 2D markers may be generated and may be scanned by the mobile client to connect that session. 2D marker may include a superposition of Vuforia Frame Marker, Vumark coded targets, and/or QR code. The 2D marker may contain the collaboration session ID. Vuforia Frame Marker may allow the app to recognize the area containing QR code from a reasonably far distance and display a hint to the user to zoom in the camera to scan the code.

On supported viewer devices, an augmentation model may be displayed in stereo, by rendering view for each eye from slightly different angles.

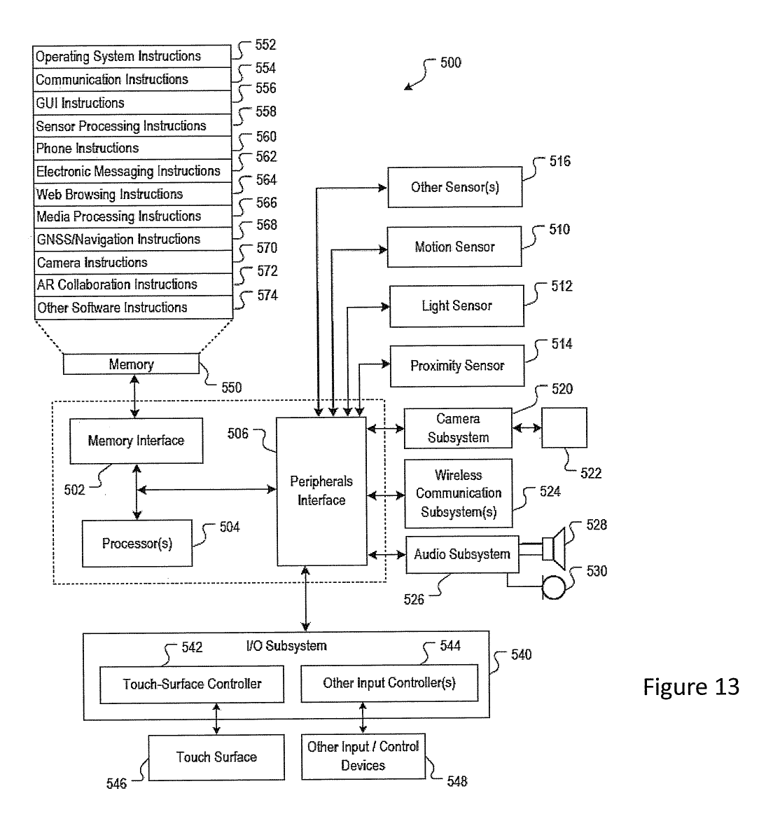

FIG. 13 is a block diagram of an example computing device 500 that may implement the features and processes of FIGS. 1-12. For example, computing device 500 may be a user device that interacts with server and other devices to collaborate in an AR environment. The computing device 500 may include a memory interface 502, one or more data processors, image processors, and/or central processing units 504, and a peripherals interface 506. The memory interface 502, the one or more processors 504, and/or the peripherals interface 506 may be separate components or may be integrated in one or more integrated circuits. The various components in the computing device 500 may be coupled by one or more communication buses or signal lines.

Sensors, devices, and subsystems may be coupled to the peripherals interface 506 to facilitate multiple functionalities. For example, a motion sensor 510, a light sensor 512, and a proximity sensor 514 may be coupled to the peripherals interface 506 to facilitate orientation, lighting, and proximity functions. Other sensors 516 may also be connected to the peripherals interface 506, such as a global navigation satellite system (GNSS) (e.g., GPS receiver), a temperature sensor, a biometric sensor, magnetometer, or other sensing device, to facilitate related functionalities.

A camera subsystem 520 and an optical sensor 522, e.g., a charged coupled device (CCD) or a complementary metal-oxide semiconductor (CMOS) optical sensor, may be utilized to facilitate camera functions, such as recording photographs and video clips. The camera subsystem 520 and the optical sensor 522 may be used to collect images of a user to be used during authentication of a user, e.g., by performing facial recognition analysis.

Communication functions may be facilitated through one or more wireless communication subsystems 524, which can include radio frequency receivers and transmitters and/or optical (e.g., infrared) receivers and transmitters. For example, the BTLE and/or WiFi communications described above may be handled by wireless communication subsystems 524. The specific design and implementation of the communication subsystems 524 may depend on the communication network(s) over which the computing device 500 is intended to operate. For example, the computing device 500 may include communication subsystems 524 designed to operate over a GSM network, a GPRS network, an EDGE network, a WiFi or WiMax network, and a Bluetooth™ network. For example, the wireless communication subsystems 524 may include hosting protocols such that the device 500 can be configured as a base station for other wireless devices and/or to provide a WiFi service.

An audio subsystem 526 may be coupled to a speaker 528 and a microphone 530 to facilitate voice-enabled functions, such as speaker recognition, voice replication, digital recording, and telephony functions. The audio subsystem 526 may be configured to facilitate processing voice commands, voiceprinting, and voice authentication, for example.

The I/O subsystem 540 may include a touch-surface controller 542 and/or other input controller(s) 544. The touch-surface controller 542 may be coupled to a touch surface 546. The touch surface 546 and touch-surface controller 542 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 546.

The other input controller(s) 544 may be coupled to other input/control devices 548, such as one or more buttons, rocker switches, thumb-wheel, infrared port, USB port, and/or a pointer device such as a stylus. The one or more buttons (not shown) may include an up/down button for volume control of the speaker 528 and/or the microphone 530.

In some implementations, a pressing of the button for a first duration may disengage a lock of the touch surface 546; and a pressing of the button for a second duration that is longer than the first duration may turn power to the computing device 500 on or off. Pressing the button for a third duration may activate a voice control, or voice command, module that enables the user to speak commands into the microphone 530 to cause the device to execute the spoken command. The user may customize a functionality of one or more of the buttons. The touch surface 546 can, for example, also be used to implement virtual or soft buttons and/or a keyboard.

In some implementations, the computing device 500 may present recorded audio and/or video files, such as MP3, AAC, and MPEG files. In some implementations; the computing device 500 may include the functionality of an MP3 player, such as an iPod™ The computing device 500 may, therefore, include a 36-pin connector that is compatible with the iPod. Other input/output and control devices may also be used.

The memory interface 502 may be coupled to memory 550. The memory 550 may include high-speed random access memory and/or non-volatile memory, such as one or more magnetic disk storage devices, one or more optical storage devices, and/or flash memory (e.g., NAND, NOR). The memory 550 may store an operating system 552, such as Darwin, RTXC, LINUX, UNIX, OS X, WINDOWS, or an embedded operating system such as VxWorks.

The operating system 552 may include instructions for handling basic system services and for performing hardware dependent tasks. In some implementations, the operating system 552 may include a kernel (e.g., UNIX kernel), and/or device drivers for the peripherals interfaces 506 and the I/O subsystem 540. In some implementations, the operating system 552 may include instructions for performing voice authentication.

The memory 550 may also store communication instructions 554 to facilitate communicating with one or more additional devices, one or more computers and/or one or more servers. The memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GNSS/Navigation instructions 568 to facilitate GNSS and navigation-related processes and instructions; and/or camera instructions 570 to facilitate camera-related processes and functions.

The memory 550 may store AR collaboration instructions 572 to facilitate other processes and functions, such as the AR collaboration processes and functions as described with reference to FIGS. 1-12.

The memory 550 may also store other software instructions 574, such as web video instructions to facilitate web video-related processes and functions; and/or web shopping instructions to facilitate web shopping-related processes and functions. In some implementations, the media processing instructions 566 may be divided into audio processing instructions and video processing instructions to facilitate audio processing-related processes and functions and video processing-related processes and functions, respectively.

Each of the above identified instructions and applications may correspond to a set of instructions for performing one or more functions described above. These instructions need not be implemented as separate software programs, procedures, or modules. The memory 550 may include additional instructions or fewer instructions. Furthermore, various functions of the computing device 500 may be implemented in hardware and/or in software, including in one or more signal processing and/or application specific integrated circuits.

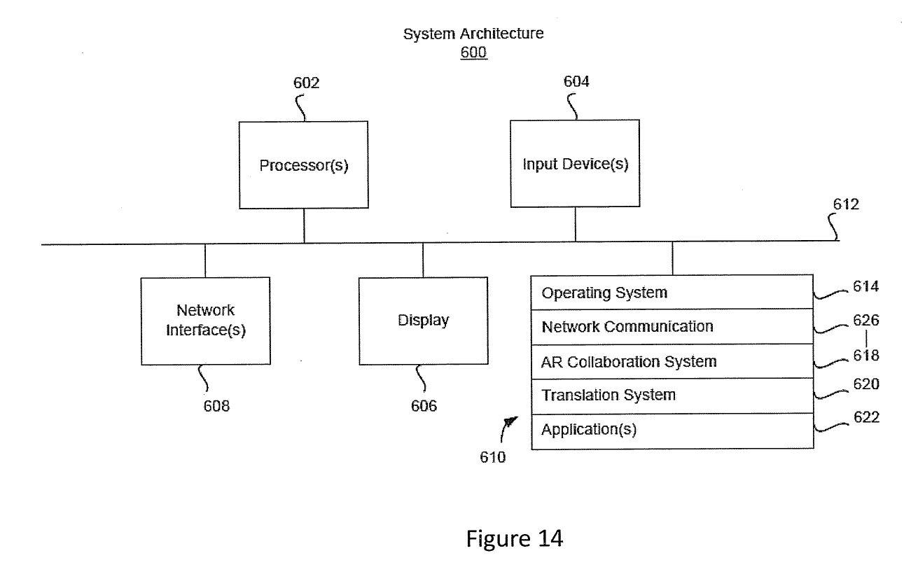

FIG. 14 is a block diagram of an example system architecture implementing the features and processes of FIGS. 1-12. The architecture 600 may be implemented on any electronic device that runs software applications derived from compiled instructions, including without limitation personal computers, servers, smart phones, media players, electronic tablets, game consoles, email devices, etc. In some implementations, the architecture 600 may include one or more processors 602, one or more input devices 604, one or more display devices 606, one or more network interfaces 608, and one or more computer-readable mediums 610. Each of these components may be coupled by bus 612.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA, mini-SATA or FireWire. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which may be controlled directly or through an I/O controller; and managing traffic on bus 612. Network communications instructions 616 may establish and maintain network connections (e.g., software for implementing communication protocols, such as TCP/IP, HTTP, Ethernet, etc.).

An AR collaboration system 618 may provide the server-side AR collaboration features and functions described above with respect to FIGS. 1-12. In some embodiments, a translation system 620 may provide the translation features and functions described above with respect to FIGS. 1-12.

Application(s) 622 may be an application that uses or implements the processes described in reference to FIGS. 1-12. The processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an APL An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the APL

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently:flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method of Augmented Reality collaboration implementation on a computer server for sharing a 3D object model simultaneously with a plurality of electronic devices, comprising the steps of:
uploading one or more 3D object model files to the server;
publishing a session identifier associated with the universal sharing files;
receiving a request containing the session identifier from the plurality of electronic devices, and
distributing a universal file of the 3D object model to the plurality of electronic devices in real-time synchronously.

2. A method of claim 1 further comprising the step of converting the 3D object model files into one or more universal files with a predefined file format, wherein the universal files can be displayed on the plurality of electronic devices as stereographic presentation.

3. A method of claim 2, wherein the step of converting the 3D object model files, further comprises the step of invoking a remote application programming interface (API) of a remote server over the Internet, wherein the API is adapted to forward the 3D object model file to the remote server, and return the universal file.

4. A method of claim 3, wherein the 3D object model files is different to the universal file format.

5. A method of any one of claims 1 to 4, further comprising the steps of:
receiving a modification request from one of the plurality of electronic devices,
modifying the universal files in according with the modification request,
sending one or more modified universal files to others of the plurality of electronic devices in real-time synchronously.

6. A method of claim 5, wherein the step of modification the universal files further comprising the steps of invoking another remote application programming interface (API) of a remote server over the Internet, wherein the API is adapted to forward the 3D object model file to the remote server, and return the universal file.

7. A method of claim 5 or claim 6, wherein the modification request comprises one or more manipulation of the 3D object model.

8. A method of claim 7, wherein the manipulation of the 3D object comprises one or more of rotation, pan, zoom, explode, animate, hide a part, show a part, highlight a part, display part information, present in a perspective views.

9. A method of any one of claims 5 to 8, wherein the modification request comprises one or more manipulation of scene objects.

10. A method of claim 9, wherein the manipulation of the scene object comprising one or more of modifying viewport, modifying light source, modifying ambient light, modifying camera position, and modifying background.

11. A method of Augmented Reality collaboration of any one of claims 1 to 10, wherein the session identifier comprises a Uniform Resource Locator (URL) bar code and/or two-dimension barcode.

12. A method of Augmented Reality collaboration of any one of claims 1 to 11, wherein the step of distributing a universal file of the 3D object model include distribution of a media steam in real-time along with the universal file of 3D object model.

13. A method of Augmented Reality collaboration of any one of claims 1 to 12, wherein the step of uploading one or more 3D object model files to the server comprising the steps of connecting to a physical object through a wireless means, and retrieving the 3D object model file of said physical object from said physical object.

14. A method of Augmented Reality collaboration for implementing on a first electronic device for simultaneous sharing 3D object model with other electronic devices, comprising the steps of:
sending a request to a server,
receiving a universal file of the 3D object model in real-time synchronously with other electronic devices, wherein the universal file converted from the 3D object model file uploaded to the server;
displaying the universal file on the display as a stereographic presentation.

15. A method of Augmented Reality collaboration of claim 14, further comprising the step of scanning an image, and retrieving a session identifier associated to the image.

16. A method of Augmented Reality collaboration of claim 15, wherein the image comprises a URL, barcode and/or two-dimension barcode, wherein the electronic device retrieves the session identifier in the image.

17. A method of Augmented Reality collaboration of claim 15, wherein the image comprises a real-life object, wherein the electronic device is adapted to connecting to the server, and retrieving the session identifier associated with the image.

18. A method of Augmented Reality collaboration of any one of claims 14 to 17, wherein the step of sending the request comprising the steps of:
opening a network socket on the server; and
forwarding the request to the server through the network socket, wherein the request comprising the session identifier and the host name.

19. A method of Augmented Reality collaboration of any one of claims 14 to 18, further comprising the steps of:
receiving an input from a user to modify the stereographic presentation, and
sending a modification request to the server.

20. A method of Augmented Reality collaboration any one of claims 14 to 19, further comprising the steps of:
receiving one or more universal files from the server; and
displaying the one or more modified universal files in real-time synchronously with one or more electronic devices sharing a same session identifier.

21. An electronic device comprising:
a processor;
a peripherals interface comprising an electronic communication system for communicating with a server or other electronic device via one or more of wired or wireless communication protocol;
a memory interface for storing instructions set to be executed by the processor; and
an input and output (I/O) subsystem for receiving inputs and displaying output,
wherein the processor is adapted to execute the instructions set for a method comprising the steps of:
sending a request to the server through the peripherals interface,
receiving a universal file of the 3D object model through the peripherals interface in real-time synchronously with other electronic devices, wherein the universal file is converted from the 3D object model file uploaded to the server;
displaying the universal file on the touch surface as a stereographic presentation.

22. An electronic device of claim 21, wherein the processor is adapted to execute the instructions set for a method comprising the steps of:
receiving an input from a user on the touch surface to modify the stereographic presentation,
sending a modification request to the server based on the input, wherein the modification request is encoded in a file format different to that of the universal file format;
receiving one or more universal files from the server; and
displaying on the touch screen the one or more modified universal files in real-time synchronously with one or more electronic devices sharing a same session identifier.

23. An electronic device of claim 21 or claim 22, wherein the input and output (I/O) subsystem comprises a touch-surface controller for controlling a touch surface, or a pointer device controller for controlling a pointer device.
